(19) United States
(12) Patent Application Publication
(10) Pub. No.: US 2017/0351975 A1
(43) Pub. Date: Dec. 7, 2017

(54) SYSTEM AND METHOD FOR MANAGING A RESERVATION FOR A VEHICLE PARKING LOCATION

(71) Applicant: Dock, Inc., Los Angeles, CA (US)

(72) Inventor: Emily Webb, Los Angeles, CA (US)

(73) Assignee: Dock, Inc., Los Angeles, CA (US)

(21) Appl. No.: 15/175,158

(22) Filed: Jun. 7, 2016

(51) Int. Cl. G06Q 10/02; G06F 17/30; H04W 4/02; G06Q 50/30

(52) U.S. Cl. CPC G06Q 10/02; H04W 4/02; G06F 17/30864; G06Q 50/30

(57) ABSTRACT

A system and method for managing a vehicle parking location is provided. The method includes receiving an available vehicle parking listing including a parking location from a host computing device over a network; storing the listing in a memory of an administrative computing device; allowing a guest computing device to view the listing on a display of the guest; receiving a parking reservation request from the guest over the network, wherein the request includes reservation start and end times; establishing a parking reservation in response to the request; terminating the parking reservation upon expiration of the reservation end time; and verifying that the parking location is vacant after expiration of the reservation end time by determining that a geographic location of the guest is greater than a predetermined distance from the parking location and determining that a speed of the guest is greater than a predetermined speed.

### FIELD OF THE INVENTION

The present invention relates generally to a system and method for managing a reservation for a vehicle parking location in a computer network environment; more particularly, the system and method may provide for an automatic acceptance of a parking reservation for a vehicle parking location, provide for an extension of time for an existing vehicle parking reservation within a certain time period before an end time of the existing reservation, and/or provide for a check-out of an existing parking reservation if it is determined that a guest or user mobile computing device associated with the existing reservation is located equal to or greater than a predetermined geographic distance from the vehicle parking location and/or is moving at a speed that is equal to or greater than a predetermined rate of speed.

### BACKGROUND OF THE INVENTION

In over-populated and crowded cities, vehicle parking locations can be scarce and difficult to locate. Within a city environment, many public vehicle parking spaces are available in parking garages, outdoor parking lots, and metered street parking. While there is typically an abundant amount of parking spaces available in parking garages and outdoor parking lots, the cost at parking such locations may be high relative to other options and some people are not comfortable navigating their vehicle in such environments. Furthermore, these parking options may not be in close proximity to the person's destination. As such, it is not uncommon for people to seek out metered street parking as a first alternative. However, there are drawbacks to metered street parking in that sometimes these spaces fill up quickly given their limited availability and do not provide for any flexibility. The nature of metered parking requires that a specific and inflexible time period be identified at the outset of parking. This forces the individual to either overpay the metered parking to make sure there is sufficient time or rush back to the vehicle with the risk of going beyond the metered time and getting ticketed for a parking violation.

Accordingly, what is needed is a system and method for connecting users to a parking network that provides for searching of available vehicle parking locations, reservation of such vehicle parking locations, and management of a reservation of a vehicle parking location to provide time flexibility for such a reservation while at the same time closely tailoring the cost of parking to the actual time spent in the vehicle parking location. The present invention fills these needs as well as other needs.

### SUMMARY OF THE INVENTION

Briefly described, the present invention provides a system and method for managing a reservation of a vehicle parking location which addresses one or more of the above-referenced deficiencies. In particular, the method is programmed for execution in a computing environment and comprises the steps of: receiving an available vehicle parking listing from a host computing device over a network, the available vehicle parking listing including a vehicle parking location; storing the available vehicle parking listing in a memory of an administrative computing device; allowing a guest (user) computing device to search, view, and select the available vehicle parking listing on a display of the guest computing device; receiving a parking reservation request from the guest computing device over the network, wherein the parking reservation request is associated with the available vehicle parking listing, and wherein the parking reservation request includes a reservation start time and a reservation end time; establishing a parking reservation in response to the parking reservation request; terminating the parking reservation upon expiration of the reservation end time; and verifying that the vehicle parking location is vacant after expiration of the reservation end time by determining that a geographic location of the guest computing device is equal to or greater than a predetermined distance (e.g., 0.25 miles) from the vehicle parking location, using for example, a GPS function of the guest computing device, and determining that a speed of the guest computing device is equal to or greater than a predetermined speed (e.g., 20 miles per hour), using for example an accelerometer function of the guest computing device.

In another aspect, the method may further comprise the step of communicating an extension of time notification to the guest computing device at a predetermined time prior to the reservation end time, wherein the extension of time notification allows the guest computing device to modify the reservation end time. In yet another aspect, the method may further comprise the step of automatically establishing the parking reservation in response to the parking reservation request as long as there is no other parking reservation that follows within a predetermined time of the reservation end time of the parking reservation request.

In another aspect, the method may provide the step of receiving an acceptance notification from the host computing device prior to the step of establishing the parking reservation in response to the parking reservation request. Further, the step of terminating the parking reservation may further include receiving a check-out notification from the guest computing device indicating that the vehicle parking location is vacant.

In another aspect, the method may be embodied in a non-transitory computer-readable medium having thereon computer-executable instructions for performing the above-referenced steps.

In yet another aspect, the method may be implemented in a vehicle parking reservation system for managing a parking reservation of a vehicle parking location. The system may comprise an administrative computing device including a memory and a processor, wherein the administrative computing device is in communication with a host computing device and a guest computing device over a network. The system may further include a reservation management module stored in the memory, wherein the reservation management module includes computer instructions that are executable by the processor. The reservation management module is configured to: a) receive an available vehicle parking listing from the host computing device over the network, wherein the available vehicle parking listing includes a vehicle parking location; b) store the available vehicle parking listing in the memory; c) allow the guest computing device to view the available vehicle parking listing on a display of the guest computing device; d) receive a parking reservation request from the guest computing device over the network, wherein the parking reservation request is associated with the available vehicle parking listing, and wherein the parking reservation request includes a reservation start time and a reservation end time; e) establish a parking reservation in response to the parking reservation request; f) terminate the parking reservation upon expiration of the reservation end time; and g) verify that the parking location is vacant after expiration of the reservation end time by determining that a geographic location of the guest computing device is equal to or greater than a predetermined distance from the vehicle parking location and determining that a speed of the guest computing device is equal to or greater than a predetermined speed.

The reservation management module may be further configured to communicate an extension of time notification to the guest computing device at a predetermined time prior to the reservation end time, wherein the extension of time notification allows the guest computing device to modify the reservation end time. The reservation management module may be further configured to automatically establish the parking reservation in response to the parking reservation request as long as there is no other parking reservation that follows within a predetermined time of the reservation end time of the parking reservation request.

Additional benefits of the above-described system and method for managing a reservation of a vehicle parking location are set forth in the following discussion.

### BRIEF DESCRIPTION OF THE DRAWINGS

FIG. 1 is a schematic diagram showing an exemplary vehicle parking reservation system that may be used to implement one or more aspects of the present invention;

FIG. 2 is a flow diagram showing an exemplary method that may be implemented by a reservation management module using the system shown in FIG. 1;

FIGS. 3A-3L are exemplary screen shots that are generated using the reservation management module;

FIG. 4A is a flow diagram representing a method including one or more aspects of the present invention;

FIG. 4B is a continuation of the flow diagram of FIG. 4A; and

FIG. 5 is a block diagram generally illustrating a computing environment in which the invention may be implemented.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

Generally, the present invention is related to a vehicle parking reservation system that allows for listing of available vehicle parking locations, searching of available vehicle parking locations, reservation of an available vehicle parking location, and management of a reservation of a vehicle parking location. It should be understood that the present system and method may be implemented in hardware, software or a combination thereof, and may be distributed across a variety of computing devices. The present system and method for managing the reservation may include, but is not limited to, providing for an automatic acceptance of a parking reservation for a vehicle parking location, providing for an extension of time for an existing vehicle parking reservation within a certain time period before an end time of the existing registration, and/or providing for a check-out of an existing parking reservation if it is determined that a guest mobile computing device associated with the existing parking reservation is located equal to or greater than a predetermined geographic distance from the vehicle parking location and/or is moving at a speed that is equal to or greater than a predetermined rate of speed. These aspects may provide time flexibility to reserved vehicle parking spaces while at the same time closely tailoring the cost of parking to the actual time spent in the vehicle parking location. It should be understood that the aspects of the present invention may be directed to both public and/or private parking locations.

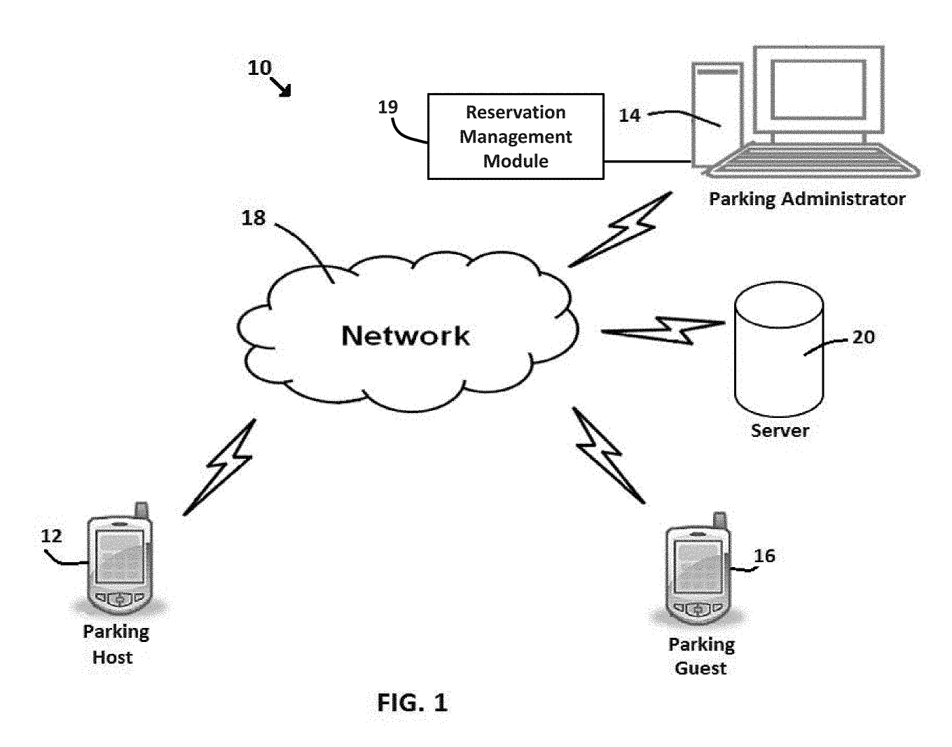

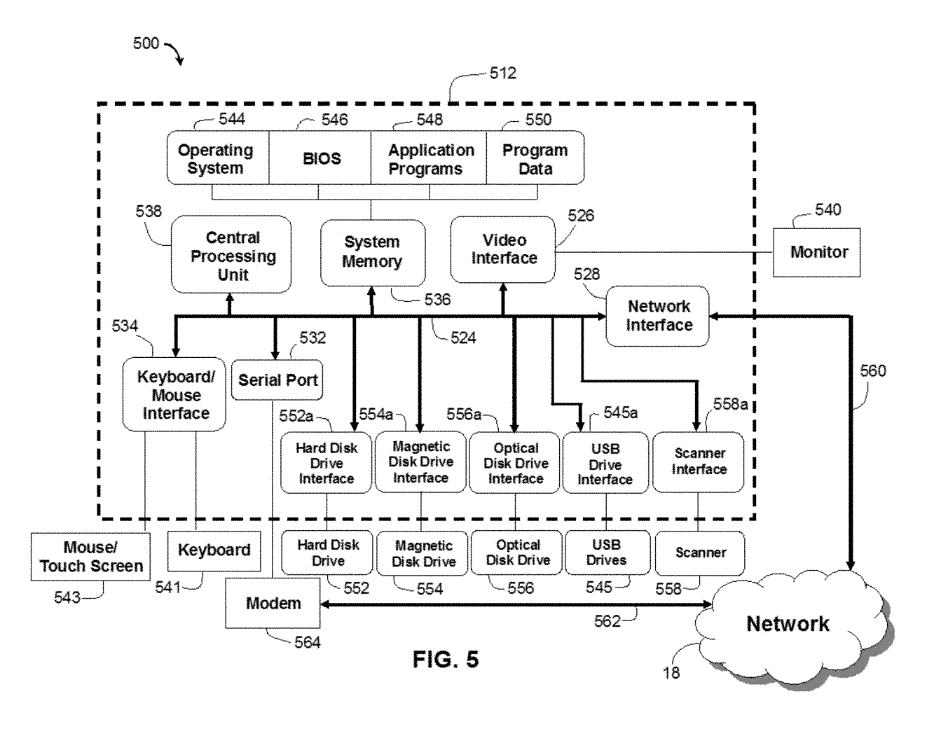

Referring to the drawings, and initially to FIG. 1, a vehicle parking reservation system that may be used to implement the various aspects and methods of present invention is generally indicated by reference numeral 10. System 10 may include a parking host computing device 12 (“host”), an parking administrator computing device 14 (“administrator”), and a parking guest computing device 16 (“guest” or “user”) in communication via a network 18, such as a Local Area Network (LAN), Wide Area Network (WAN), Wireless network or other similar configuration for allowing communication among a plurality of computing devices. One or more of host 12, administrator 14, and/or guest 16 may include a memory 536 (FIG. 5), which may have a reservation management module 19 stored therein. Reservation management module 19 includes computer executable instructions programmed for execution in one or more of the computing devices 12, 14, 16 set forth in system 10 for implementing the methods described herein. Reservation management module 19 is not limited to any specific hardware or software configuration, but may rather be implemented as computer executable instructions in any computing or processing environment, including in digital electronic circuitry or in computer hardware, firmware, device driver, or software, such as, but not limited to, a downloadable mobile or desktop software application, or a web-based software platform accessible through the Internet. It should be understood that reservation management module 19 may be stored in a memory one or more of host 12, administrator 14, and/or guest 16 even though FIG. 1 shows reservation management module 19 as being associated with administrator 14. While the discussion set forth below may illustrate a particular number of available parking listings being established and managed using reservation management module 19, it should be understood that any number of available parking listings and parking reservations may be handled by reservation management module using the same methodology described herein.

Host 12 may be type of computing device that is configured for communicating data representative of an available vehicle parking listing to administrator 14 through network 18 so that administrator 14 can make the available vehicle parking location listing available for viewing and reservation by guest 16, as well as perform other functions described herein. For example, host 12 may be a desktop computer, laptop, tablet, smartphone, smart television, or other computing device that is capable of electronically communicating with computing devices in a network. The data representative of the available vehicle parking listing may include, but is not limited to, a geographic location of an available parking location, one or more periods of time that the parking location is available for reservation, a price for the available parking location, and, optionally one or more digital images of the available parking location. The digital image associated with the available parking location may be stored in a memory of host 12 or may be stored in a remote memory location (e.g., server) and retrieved via network 18 either by host 12 or administrator 14 upon communication of the available parking reservation by host 12 to administrator 14 or thereafter. It should be understood that the vehicle parking location may be either a private or public parking location.

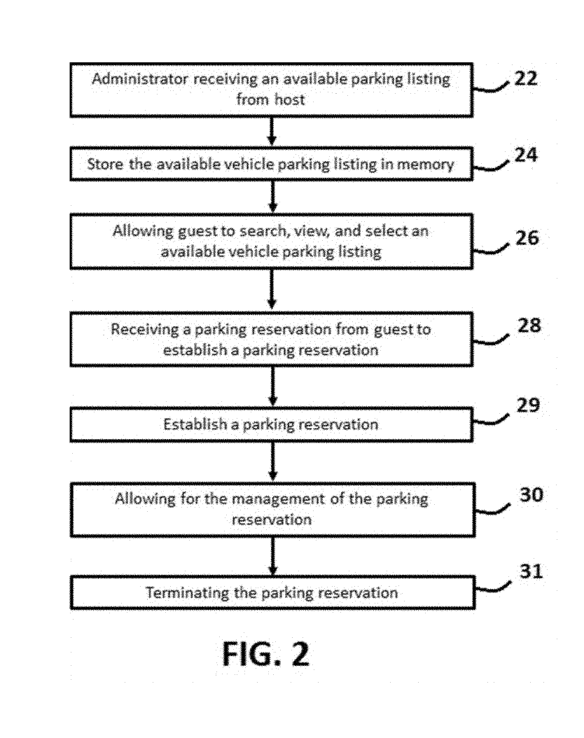

With additional reference to FIG. 2, administrator 14 may be any type of computing device that is configured for receiving data representative of the available vehicle parking listing available for reservation communicated from host 12 at step 22, and communicating or otherwise making available the available vehicle parking listing to guest 16 to allow guest 16 to reserve the available vehicle parking listing to establish a parking reservation via network 18, and provide for the management of the parking reservation as will be described in detail below. For example, administrator 14 may be a desktop computer, laptop, tablet, smartphone, smart television, or other computing device that is capable of electronically communicating with computing devices in a network. Upon receiving the data representative of the available vehicle parking listing from host 12, administrator 14 may store the available vehicle parking listing in local memory, or in a memory of an administrative server 20 via network 18, at step 24. Administrator 14 may communicate data representative of the available vehicle parking listing to guest 16 over network 18 by placing the available vehicle parking listing in a searchable database that allows guest 16 to query the available vehicle parking listing, and view the available vehicle parking listing on a display of guest 16 when selected by guest 16, at step 26. It should be understood that reservation management module 19 may also include computer executable instructions programmed for execution in server 20, alone or in combination with one or more of the computing devices 12, 14, 16 set forth in system 10, for implementing the methods described herein.

Guest 16 may be one or more mobile computing devices that are configured for searching and viewing the available vehicle parking listing that is communicated or otherwise made available by administrator 14. Guest 16 is also configured for selecting an available vehicle parking listing and communicating this selection to administrator 14, wherein this selection includes the step of providing a reservation start time 80 and a reservation end time 82. Upon administrator 14 receiving a parking reservation request communicated from guest 16 at step 28, administrator 14 may establish a parking reservation that may be stored in memory of administrator 14 and/or server 20 at step 29. Administrator 14 may then communicate or otherwise make available a notice of the parking reservation to host 12. The parking reservation selected by guest 16 may be automatically accepted by reservation management module 19, or require that host 12 provide a communication to administrator 14 and/or guest 16 that operates to accept the request for the parking reservation prior to administrator 14 establishing the parking reservation at step 28. At step 30, reservation management module 19 may then manage the parking reservation automatically or through the use of one or more of host 12, administrator 14, or guest 16 in accordance with one or more aspects of the present invention which will be described in more detail below. The parking reservation is thereafter terminated at step 31. It should be understood that guest 16 may be, but is not limited to, a smartphone, tablet, laptop, a computer integrated into an automobile, or other mobile computing device that is capable of electronically communicating with computing devices in a network.

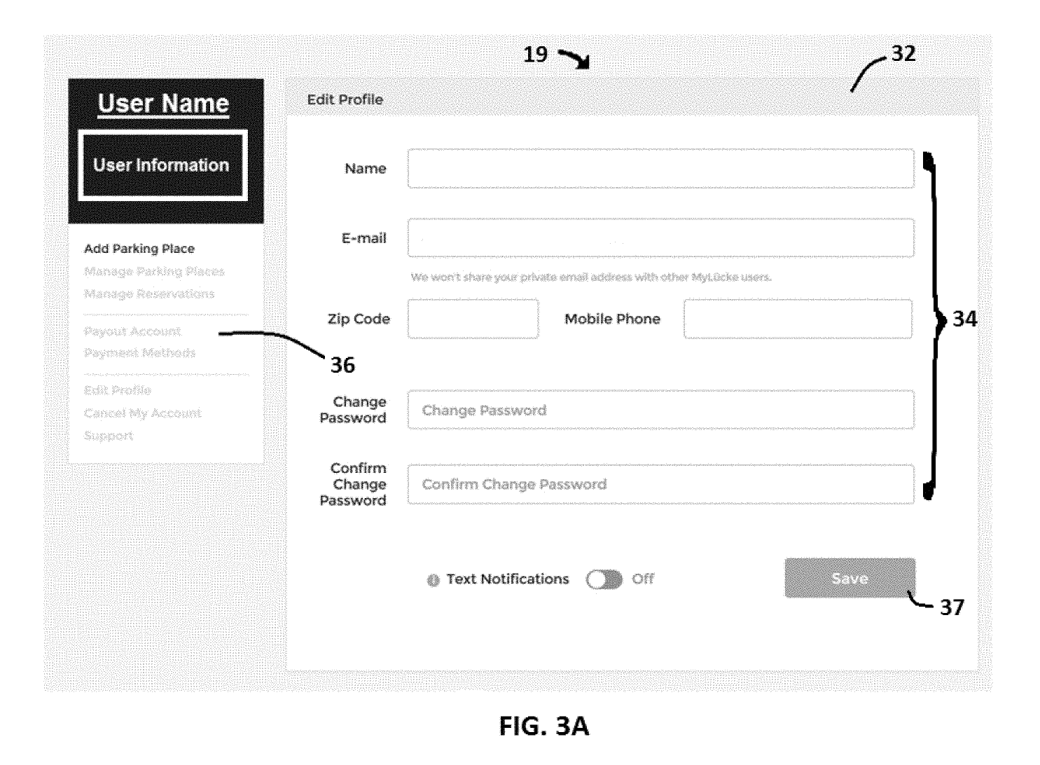

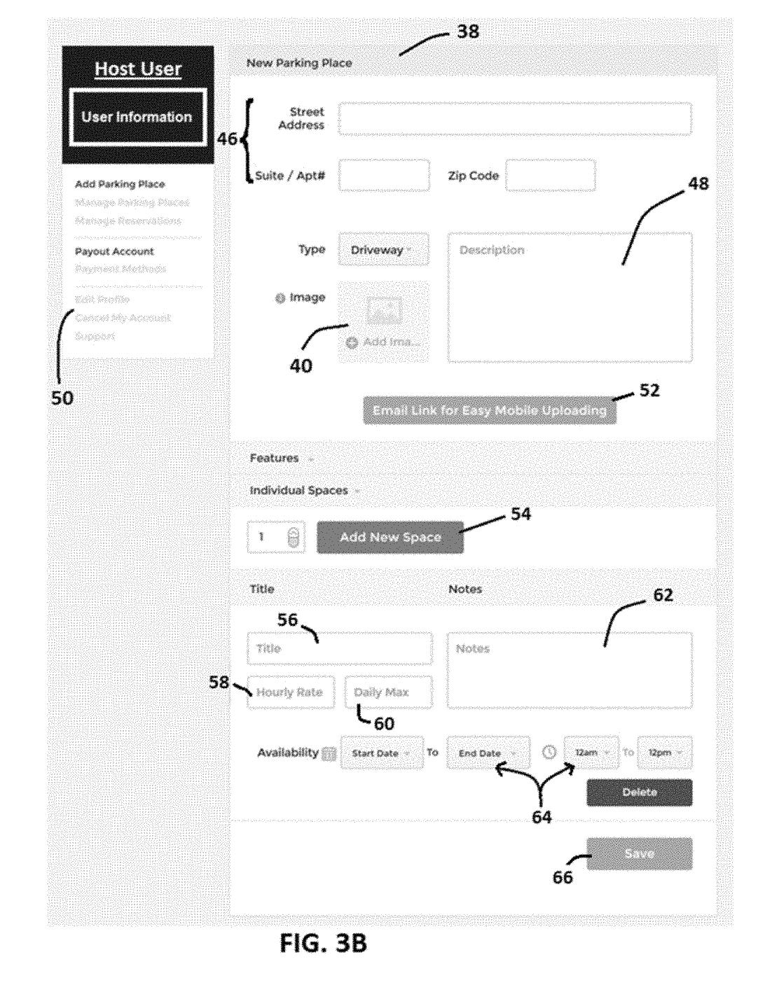

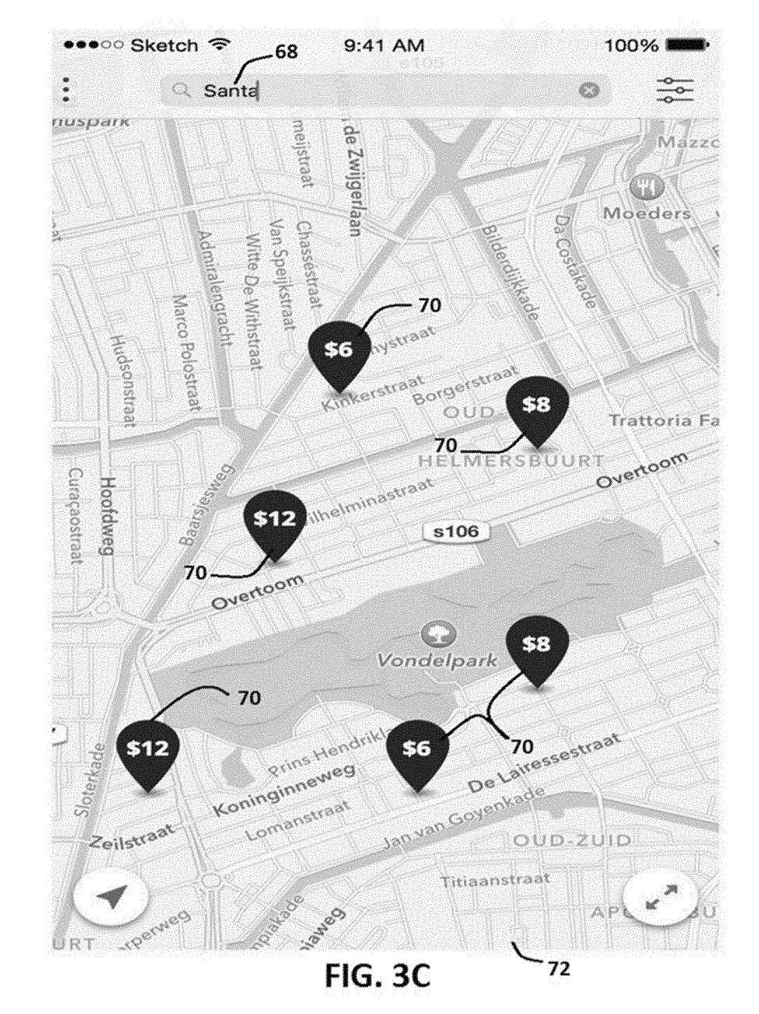

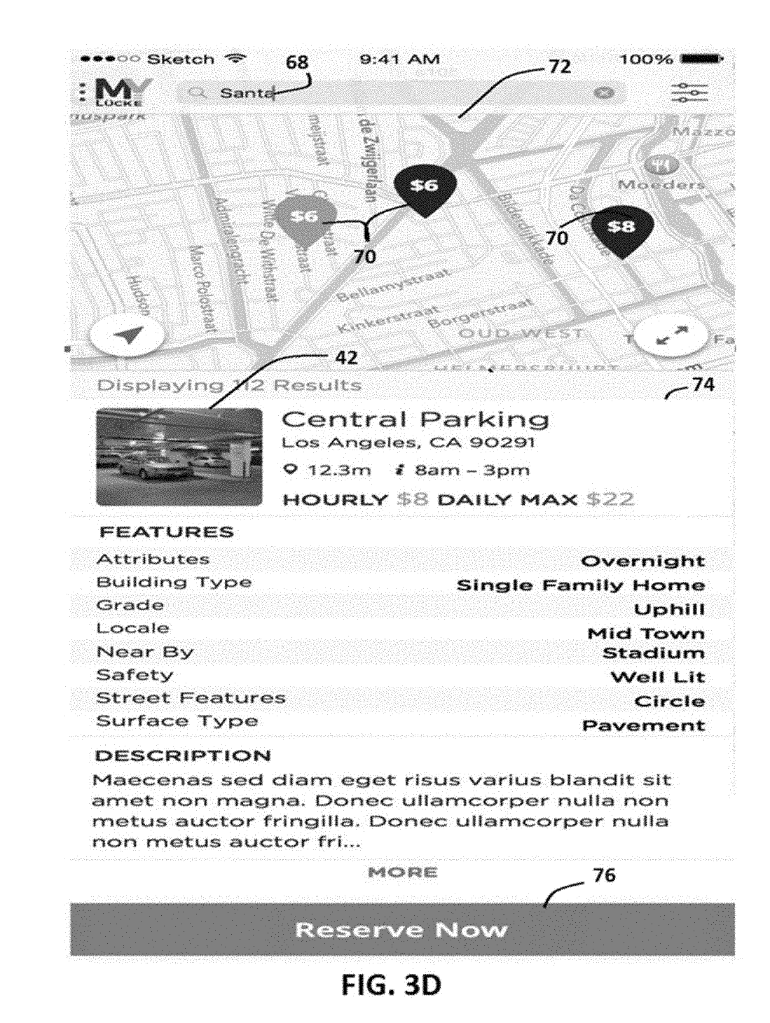

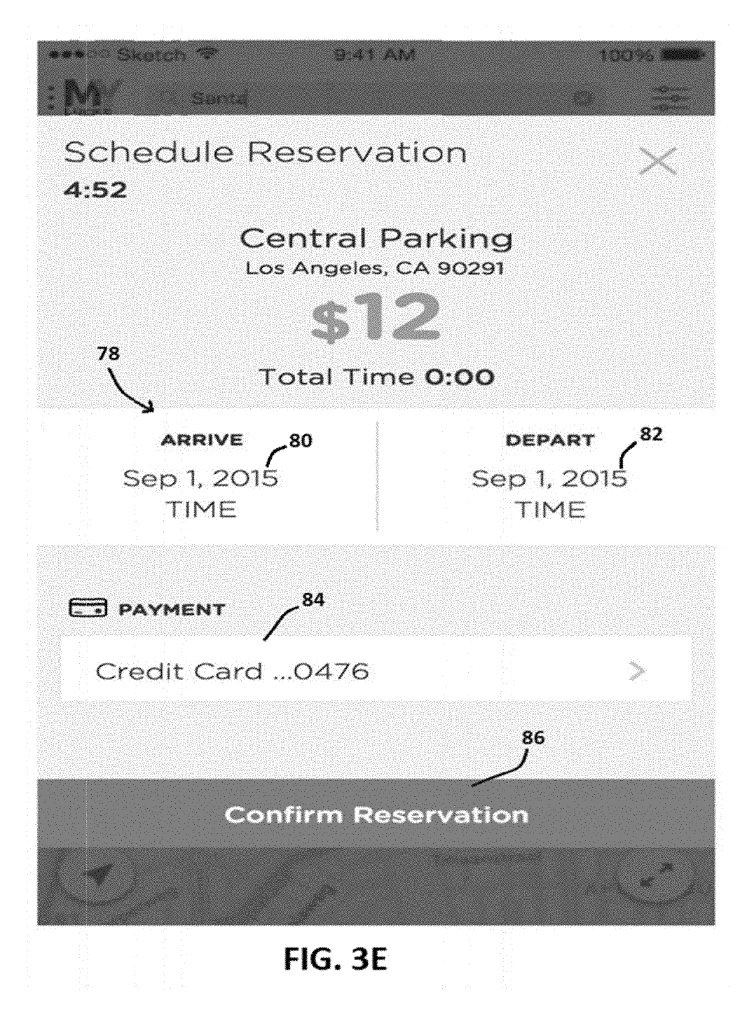

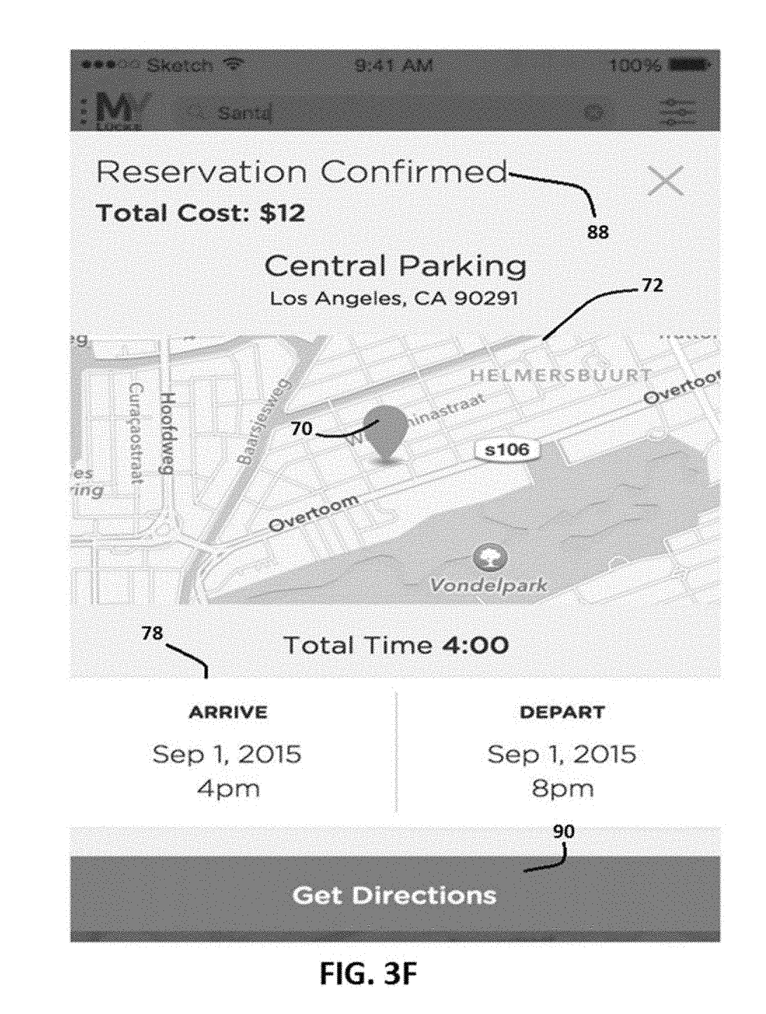

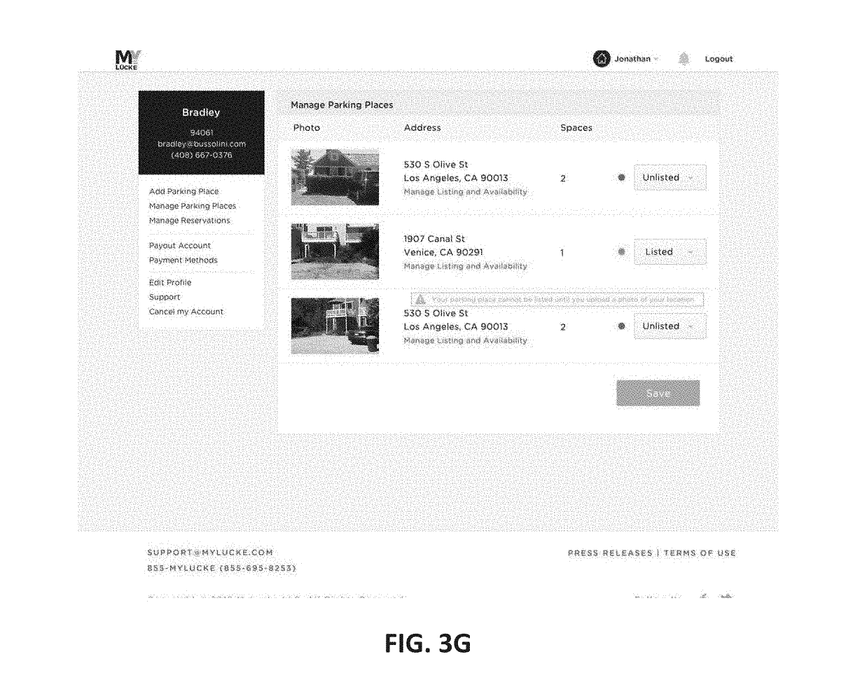

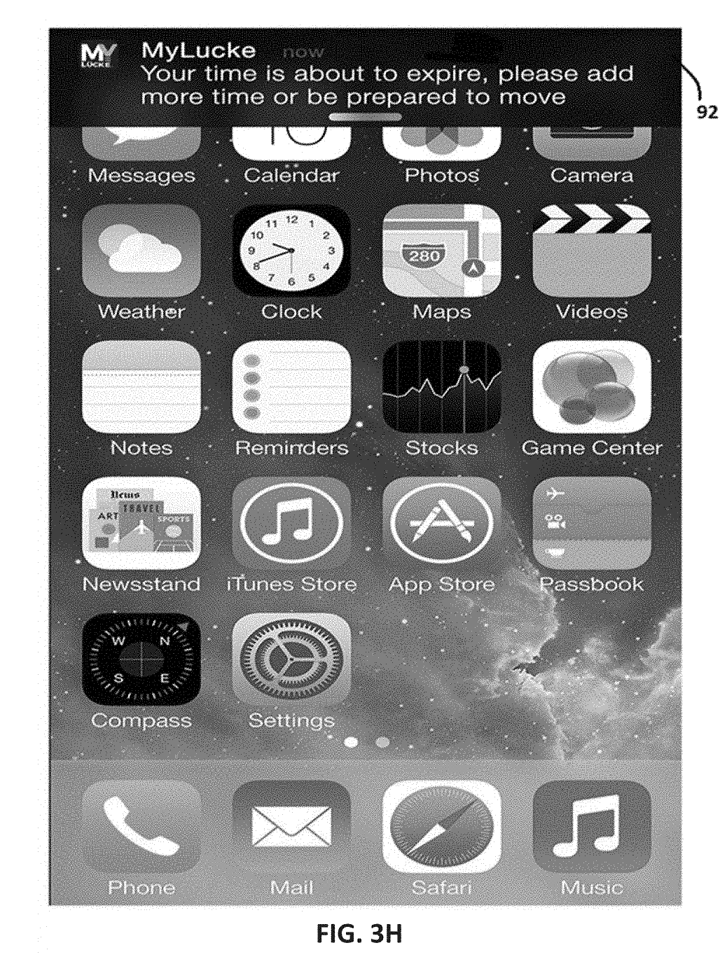

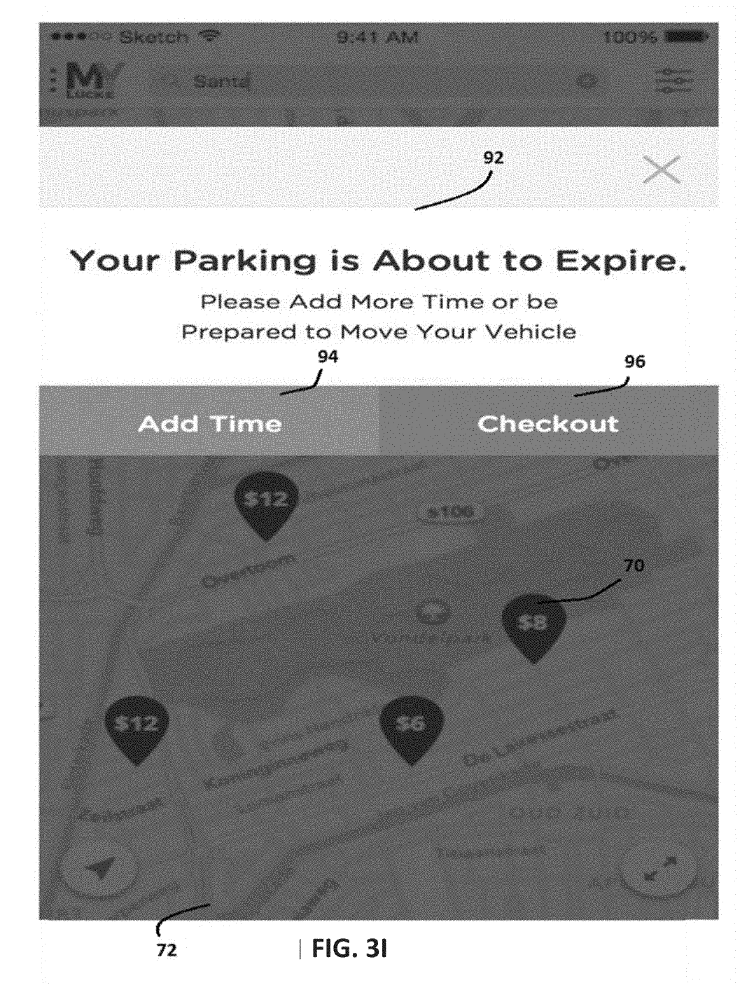

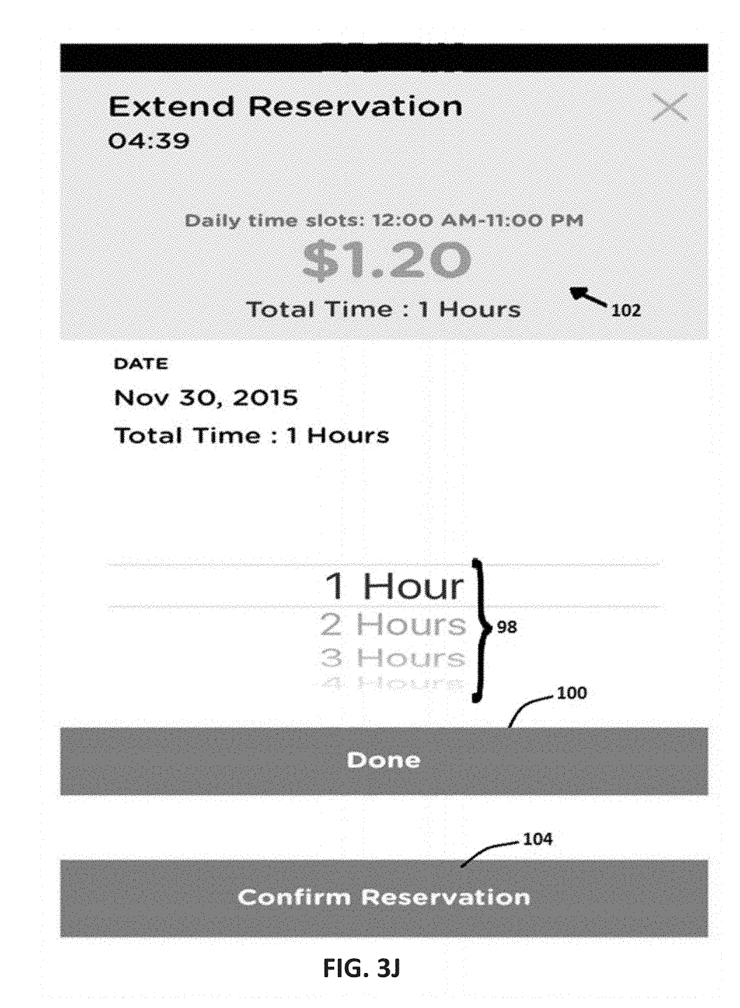

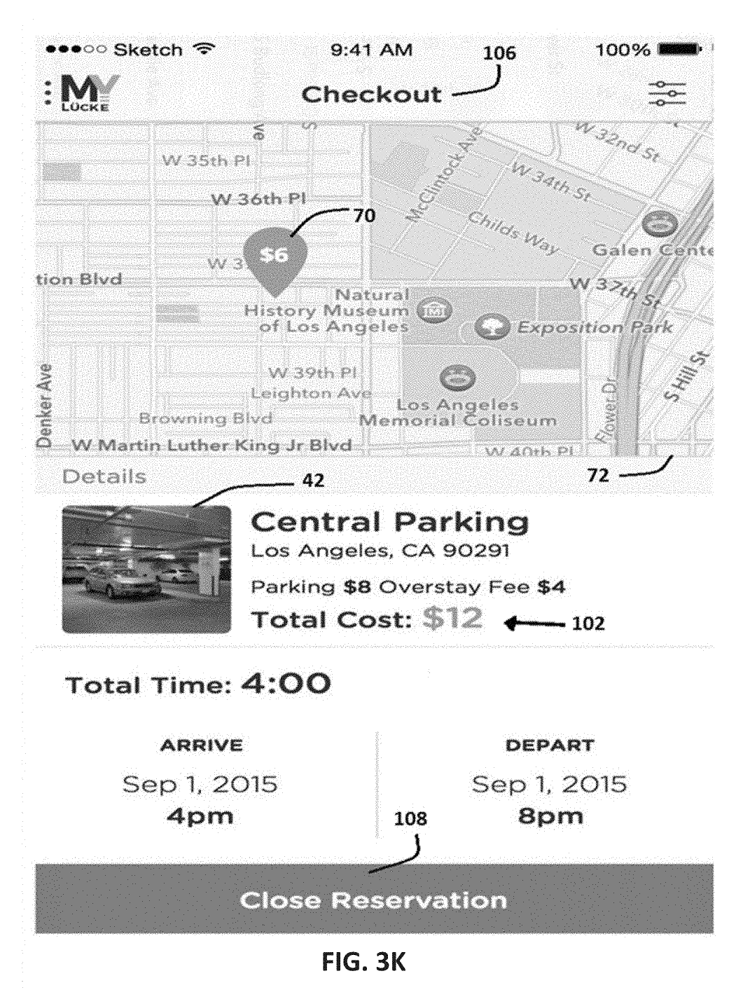

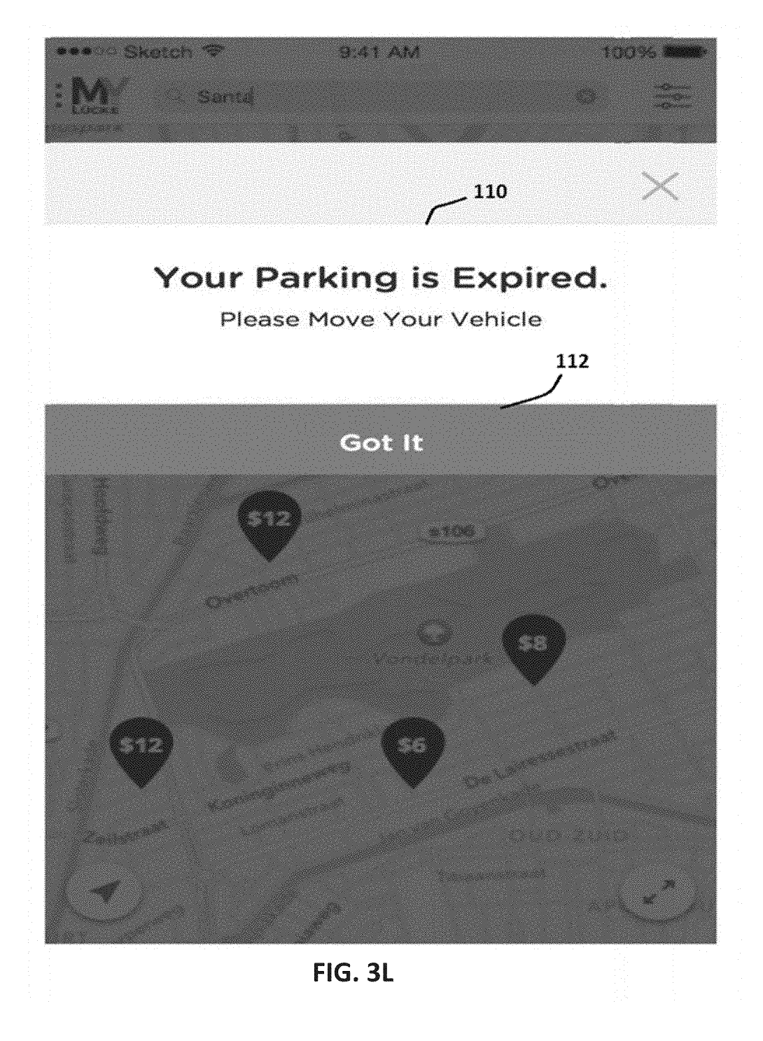

Having described the general aspects of system 10 and the methods implemented by system, an exemplary implementation will now be described with reference to the user interfaces shown in FIGS. 3A-3K and provided by the reservation management module 19 using system 10.

Referring initially to FIG. 3A, reservation management module 19 may be used to generate a user profile section 32, which a user may be directed to after logging onto reservation management module 19. User profile 32 allows any user (e.g., parking host or guest parker) to upload certain personal information and then display at least a portion of that information via a display on an associated device (e.g., host 12 or guest 16). A user profile 34 may comprise the user's personal information (e.g., name, city and state, email, phone number, billing information/address, etc.), password information, notification designation options, and generic notes. It should also be appreciated that the user may input all information manually, or at least a portion of the information may be gathered from a social media site (e.g., Facebook). Upon completion of user profile 34, reservation management module 19 may generate a notification which instructs the user on how to authenticate user profile 34 to ensure user profile 34 is not fraudulent.

User profile 34 may also allow host 12 or guest 16 to create a payment profile 36 which may include all payment information and payment processing method information (i.e., first name, last name, billing address, company, city, state, zip code, card number, card expiration date, CVV, and default card setting options). Through payment profile 36, host and guest users may be prompted to create a sub-merchant account before host 12 is able to make one or more parking locations available for reservation by guest 16, or before being able to establish a parking reservation by guest 16. Reservation management module 19 may further collaborate with at least one third-party financial services provider (e.g., Braintree, PayPal, etc.) to store payment information and/or sub-merchant account information and to process any payments, billings, and/or provide a payment gateway. Administrator 14 may be configured to create, edit, and/or delete information uploaded to user profile 34 and merchant profile 36. This may be helpful in certain instances, for example, when a host or guest user has requested deletion of their account or fraudulent activity has been made through a user profile. After all information has been entered in user profile section 32, data representative of the user profile 34 may be communicated to administrator 14 via network 18 and stored in a memory of administrator 14 upon execution of a save button 37.

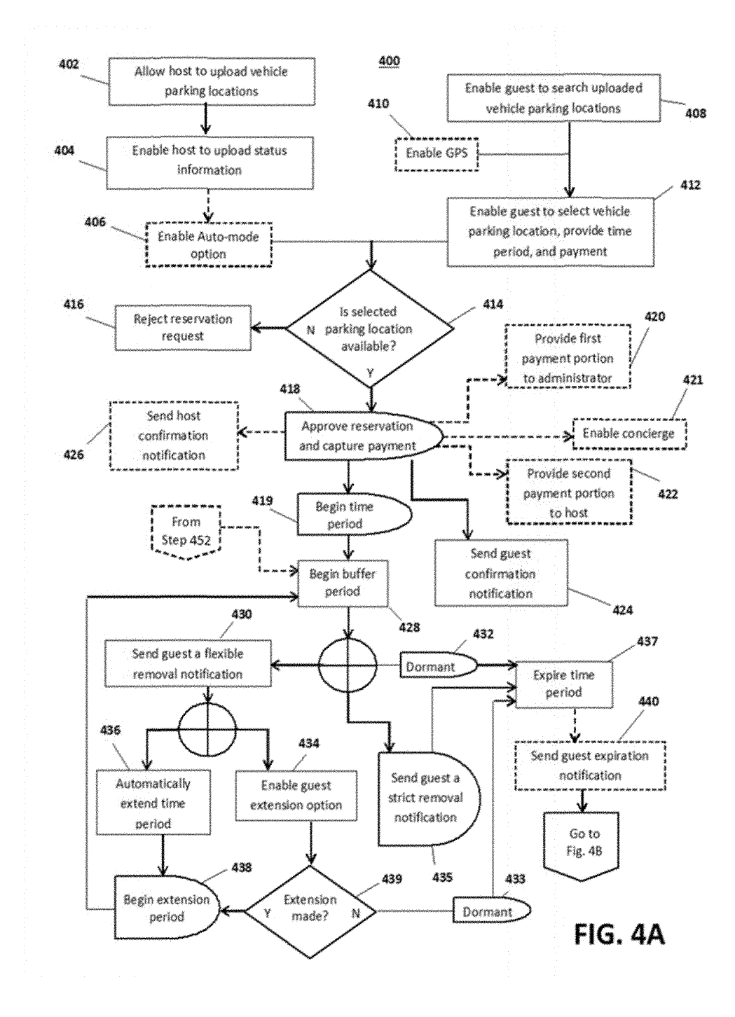

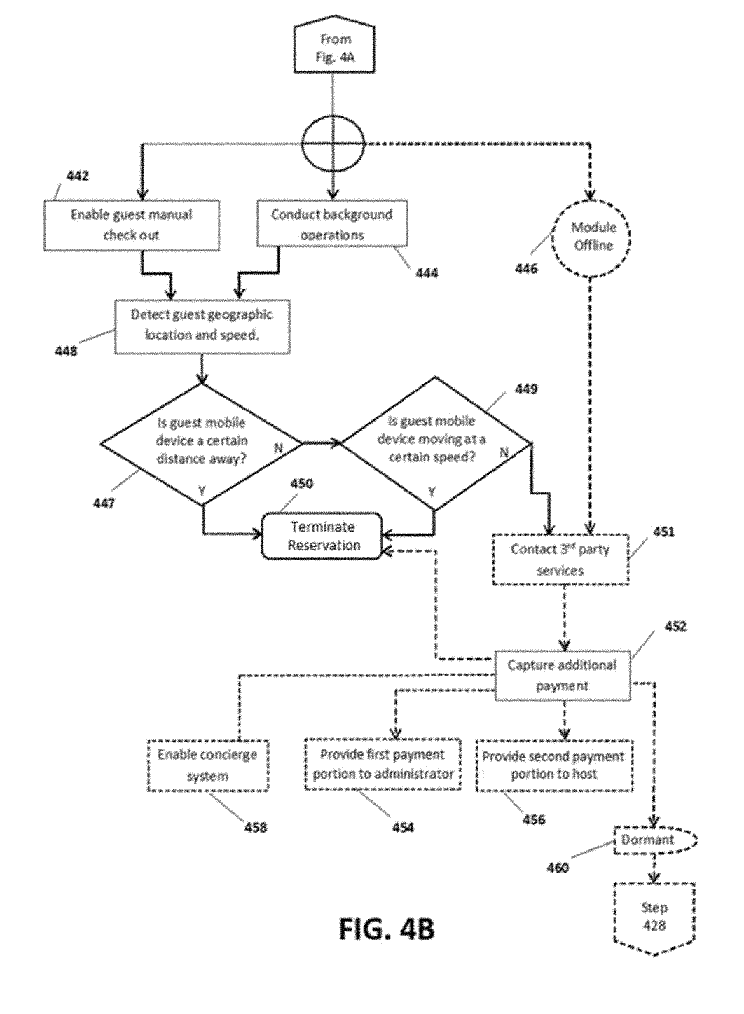

Referring now to FIG. 3B, reservation management module 19 may further include a parking location profile 38 for allowing host 12 to upload or otherwise communicate information associated with an available vehicle parking listing to administrator 14. Parking profile 38 may include a button 30 that allows host 12 to upload a digital image 42 (FIG. 4D) representative of the available parking location, selection of the type of parking location 44, and the address of the parking location 46. Parking location profile 38 may also further include a notes section 48 allowing host 12 to upload an individualized description of the parking location. The individualized parking location description may include specific characteristics such as, but not limited to, approximate square footage, nearby landmarks, and nearby hazards. Host 12 may also access and make modifications to personal user profile 34 via an edit profile button 50. Further, a button 52 for easy mobile uploading using an email link may be provided. It should be understood that an administrative user may edit/amend an uploaded available vehicle parking listing using administrator 14.

Parking location profile 38 may further include the ability to identify and designate multiple parking locations within a single location identified in parking location 46. In particular, an add new space button 54 allows host 12 to split the parking location 46 into two or more individual parking spaces for reservation, and allows host 12 to provide an individualized title for each space 56, an hourly payment rate for each space 58, a daily maximum payment amount 60, a monthly payment amount, and/or a notes section 62 that is similar to notes section 48. Parking location profile 38 may further include an availability limitation 64 for allowing host 12 to designate and edit status information for the parking location. This availability limitation 64 may relate to one or more time periods in which the parking location is available for reservation (i.e., day and time availability). As such, the parking location may be designated with a status of “available” or “unavailable” when viewed by potential guests 16 searching for a parking location using reservation management module 19 based upon available information 64 provided by host 12. In the alternative, the system may only allow potential guests 16 searching for a parking location using reservation management module 19 to see parking locations designated with an available status. Administrative users having certain rights may view and edit the status information (i.e., adding/removing parking location availability). Reservation management module 19 may include or utilize calendar and/or clock operations within host 12, administrator 14 and/or guest 16 to determine the status (i.e., “available” or “unavailable”) of a particular parking location based on availability limitation 64 specified by host 12.

Parking profile 38 may further include an auto-mode feature which is on aspect of the management feature of parking management module 19. The auto-mode feature enables reservation management module 19 to administrate reservations on behalf of host 12. When auto-mode is enabled, reservation management module 19 will automatically approve/deny reservation requests made by guest 16 without requiring any approval from host 12. However, in one aspect, the auto-mode feature may be implemented only when there is a minimum predetermined time period (e.g., thirty minutes) between an end time of one parking reservation and a start time of a subsequent parking reservation to avoid any potential issues arising from one person not leaving the parking location prior to the beginning of a subsequent parking reservation. Typically, when auto-mode is disabled, host 12 may be required to review and approve/deny all parking reservation requests by guest 16, perhaps making sure that a reservation request does not conflict with the status for the parking location. When auto-mode is enabled, host 12 will not be required to approve a parking request made by guest 16.

Parking profile 38 may further include a policy option profile that allows host 12 to select a policy for a parking location that host 12 has made available for reservation. Such policy information may concern various reservation extension restrictions. These restrictions may be reflected as policy types, such as, for example, a strict policy, flexible policy, and a cancellation policy.

The strict policy generally provides that the parking location reservation is time sensitive and a time extension to such an existing reservation is prohibited. As such, the strict policy encourages removal of the vehicle from the parking location before or at the expiration of the reservation. Under a strict policy, the reservation management module will generate and send a “strict” removal notification to guest 16 at a predefined time prior to the expiration of a reservation. This type of notification only notifies when the vehicle is required to be removed from the parking location and does not allow for reservation extensions. Reservation management module 19 may also sanction the guest parker for not complying with the restrictions of the strict policy. Such sanctions may comprise monetary penalties, loss of rights, and/or the vehicle may be removed from the parking location via a third-party removal services provider (e.g., towing services).

A flexible policy may provide for more lenient restrictions with regard to the parking reservation. This flexible policy relates to one aspect of the management of a parking reservation by reservation management module 19. The flexible policy may be used when at least one additional reservation time period (e.g., one hour) is available subsequent to the end time of the existing registration. Under a flexible policy, reservation management module 19 will generate a removal notification (FIGS. 3H-3J) which provides certain reservation extension options. This option generally allows guest parker to extend the existing reservation with substantially similar information provided when the original reservation was made. Under this policy, reservation management module 19 may also request guest 16 provide new payment information upon making a reservation extension.

A cancellation policy may provide for host 12 to designate a cancellation period. This cancellation period may be set to occur at some designated time duration prior to the commencement of the existing registration. The cancellation period may be incremental by a designated number of hours (e.g., 2 hours, 12 hours, 24 hours, etc.) or by a designated number of days (e.g., 3 days, 5 days, 7 days, etc.). As such, when a cancellation is made within the designated cancellation period, reservation management module 19 will automatically refund any payments made (i.e., via at least one third-party financial services provider) to guest 16 for the parking location. Reservation management module 19 may also be configured to notify guest 16 of the cancellation. Guest 16 may also have the option to cancel a parking reservation during the cancellation period.

After all information has been entered in parking location profile 38, data representative of the parking location profile 38, including the available vehicle parking listing, may be communicated by host 12 to, and received by, administrator 14 via network 18 and stored in a memory of administrator 14 upon execution of a save button 66. All uploaded available vehicle parking listing may be stored in a searchable database that may be accessed by one or more guest 16.

In a further aspect of reservation management module 19 as shown in FIG. 3C, reservation management module 19 may be used by guest 16 to search, view, and select available vehicle parking listings that have been uploaded by host 12. For instance, reservation management module 19 may provide a search bar 68 on a display of guest 16 to facilitate a search of available vehicle parking listings 70 based on key words entered by a user or within a specified geographical area specified by the user. To assist with the search, reservation management module 19 may also access a global positioning system (GPS) function of guest 16 to locate parking locations in a specified/general proximity of guest 16. These results may be displayed as pins populated on a map 72, and the associated price of each available vehicle parking listing per hour, for example. Guest 16 may be configured to allow a user to touch any of the pins on the display of guest 16 to view detailed information on the selected available vehicle parking listing. In certain instances, reservation management module 19 may provide user of guest 16 with a tutorial explaining how to operate reservation management module 19.

FIG. 3D shows the result of a user of guest 16 touching one of the pins on map 72 shown in FIG. 3C to view detailed information on the selected available vehicle parking listing. The detailed information 74 on the selected available vehicle parking listing may include, but is not limited to: status information for the selected available vehicle parking listing, location address, user ratings, costs, location features and description, and/or a designation indicator which correlates with the specific pin. Detailed information may also be displayed on guest 16 for multiple parking listings at the same time, wherein these detailed listings may be organized by: availability (e.g. soonest available openings), distance (e.g. nearest to farthest), cost (e.g. lowest to highest), and rating (e.g. highest to lowest). Once a suitable available vehicle parking listing is identified, a reserve now button 76 associated with the identified vehicle parking listing is selected using guest 16.

As shown in FIG. 3E, after reserve now button 76 associated with the identified vehicle parking listing is selected using guest 16, guest 16 is requested to schedule a reservation. To do so, a time profile 78 must be inputted by guest 16 including a parking location start (arrive) time 80 and a parking location end (depart) time 82, as well as payment information (e.g., credit/debit card information) via payment profile 84. Reservation management module 19 may require the guest parker to have a sub-merchant account before confirming the parking reservation. Once suitable time profile 78 and payment profile 84 are provided, guest 16 may communicate a parking reservation request to administrator 14 upon execution of a confirm reservation button 86. In certain instances, prior to the completion of the reservation request, reservation management module 19 may further require the guest parker to provide a vehicle profile that includes vehicle description information (not shown). The vehicle description information may include: make, model, color, license plate number, and any vehicle modifications (e.g., specialty tires).

Reservation management module 19 may be configured to present guest 16 with a booking wizard (not shown) after guest 16 communicates the parking reservation request to administrator 14. The booking wizard compares the time period requested by guest 16 with the status information of the available vehicle parking listing and verifies the payment method. The booking wizard may notify guest 16 if there are any issues found with the information provided in the parking reservation request. If no issues exist, the booking wizard may display on guest 16 a final review of the parking reservation request and require guest 16 to confirm the parking reservation request in order to complete the parking reservation.

As shown in FIG. 3F, based upon the parking reservation request provided by guest 16, reservation management module 19 may generate a confirmation approval notification 88 (e.g., email/SMS/push notification) of the parking reservation. Approval notification 88 allows the guest parker to review specific information regarding the parking reservation, including, but not limited to, the total cost of the parking reservation, address of the parking location, map 72 showing the parking location, and time profile 78. Approval notification 88 may, for example, is configured to allow guest 16 to obtaining directions to the location of the parking reservation via a get directions button 90. In one aspect, a parking reservation request notification (not shown) may be generated by administrator 14 and sent to host 12, for example, when auto-mode is disabled. Through the parking reservation request notification, host 12 may accept or decline the parking reservation request.

Under certain circumstances, for example, when allowed by an aforementioned policy set by the host, guest 16 may cancel a parking reservation through the user interface of confirmation approval notification 88. Once guest 16 cancels a parking reservation, reservation management module 19 may generate a cancellation notification that is communicated to host 12. After the cancellation of a parking reservation, reservation management module 19 may change the status of the parking location to “available” to allow other guest parkers to make a reservation for the cancelled time profile.

Upon generating confirmation approval notification 88, reservation management module 19 may directly or indirectly capture the payment for the parking reservation using payment profile 84 and provide such payment to host 12 and/or administrator 14. Reservation management module 19 may further set the parking location status to reflect unavailability during the time profile for the parking reservation, or host 12 can set the parking location as being unavailable as best seen in FIG. 3G. Administrator 14 may be used to view and edit confirmation approval notification 88. Reservation management module 19 may also be configured to automatically generate and communicate confirmation approval notification 88 to host 12. It should be appreciated that when the payment information communicated by guest 16 is inadequate, reservation management module 19 may automatically generate and communicate a declination notification or error notification (not shown) to guest 16.

As shown in FIG. 3H, reservation management module 19 may be configured to communicate a warning notification 92 to guest 16 at a predetermined time prior to the expiration of the parking reservation, so that warning notification 92 is displayed on guest 16. As shown in FIG. 3I, if warning notification 92 is accessed using guest 16, warning notification 92 may provide information as to a time when vehicle removal is required. Through warning notification 92, reservation management module 19 may allow guest 16 to extend the parking reservation via an add time button 94 if there will be no interference with subsequent parking reservations, or manually check-out of the parking reservation using a check-out button 96. If the add time button 94 is accessed using guest 16, a user interface shown in FIG. 3J will be displayed using guest 16. As best seen in FIG. 3J, guest 16 may be used to select an additional amount of time 98 to be added on to parking location end (depart) time 82 and confirmed using a done button 100 and guest 16 displays the amount of the additional payment via an extension payment and time extension review profile 102. Guest 16 may be used to confirm the extension of time to the parking reservation via a confirmation reservation button 104. As shown in FIG. 3K, a checkout interface 106 displays the reservation extension information using guest 16, which summarizes the selected extension options for review (e.g., location name, time information, cost information, map and pin information, etc.). Guest 16 may then be used to close checkout interface 106 via a close reservation button 60.

When calendar and/or clock operations accessed by reservation management module 19 determine that the parking reservation has expired, and guest 16 was not used to extend the parking reservation or such an extension was not available, reservation management module 19 automatically generates an expiration notification 62 as shown in FIG. 3L by calculating or otherwise determining the availability of that space, which is displayed on guest 16. Guest 16 may then be used to manually check-out of the parking reservation via a button 112, or a “close reservation” button communicated or otherwise presented to guest 16, which results in guest 16 sending a communication to administrator 14 and/or host 12 to notify that the parking location is vacated, which thereby terminates the parking reservation.

Even if guest 16 checks-out of a parking reservation, it may be desirable to verify that the vehicle associated with the parking reservation has actually vacated the parking location prior to terminating the parking reservation. In order to verify that the vehicle associated with guest 16 has been left the parking location, a management aspect of reservation management module 19 may include automatically verifying when a vehicle has left the parking location associated with the parking reservation using data representative of a current geographic location guest 16 and/or accelerometer data of guest 16. In particular, upon or after expiration of the parking location end (depart) time 82 (or any extensions thereof, if applicable), reservation management module 19 may be configured for receiving or obtaining a current geographic location of guest 16, using Global Positioning System (GPS) or Assisted GPS (AGPA) for example, and determining the distance between the current geographic location of guest 16 and the parking location associated with the parking reservation. In one aspect, if the current geographic location of guest 16 is equal to or greater than a predetermined distance from the parking location of the parking location associated with the expired parking reservation (for example, 0.25 miles), then reservation management module 19 will automatically check-out guest 16 from the parking reservation and terminate the parking reservation. In another aspect of the present invention, reservation management module 19 may also receive or obtain accelerometer data from guest 16 to determine the rate of speed in which guest 16 is moving. If the rate of speed of guest 16 is equal to or greater than a predetermined rate of speed (e.g., 20 miles per hour), then reservation management module 19 will automatically check-out guest 16 from the parking reservation and terminate the parking reservation. It should be understood that the use of the geographic location of guest 16 relative to the parking location and accelerometer data may be used together or separately to verify that the vehicle associated with the parking reservation has been removed from the parking location and automatically check-out guest 16 from the parking reservation and terminate the parking reservation.

If guest 16 is not used to manually check-out of the parking reservation, then host 12 and/or administrator 14 may not have any information to indicate whether the parking reservation should be terminated and whether subsequent parking reservations can be fulfilled or made, which could impact productivity of the particular parking location. As such, in a further management aspect of the present invention, reservation management module 19 may be configured to determine when a vehicle has left the parking location associated with the parking reservation using data representative of a current geographic location guest 16 and/or accelerometer data of guest 16, as described above, even if guest 16 is not used to manually check-out of the parking reservation, in order to terminate the parking reservation.

Having described some of the aspects that may be included in reservation management module 19, an exemplary version of machine executable instructions provided by reservation management module 19 will be described with reference to FIGS. 4A and 4B. As mentioned above, reservation management module 19 may be located in the stored memory of one or more computing devices and may be implemented for connecting users to a network so as to upload and/or reserve one or more vehicle parking locations. If reservation management module 19 is implemented, the exemplary algorithmic method 400 includes step 402 which comprises enabling a parking host to upload one or more parking locations 46 to administrator 14 from host 12. As discussed above, step 402 may be conducted through a parking location profile 38. Once the information is uploaded, method 400 will move to step 404 which comprises allowing host 12 to upload status information to designate when the parking location may be available for reservations. This step 404 may also enable host 12 to upload policy information for the parking location. At optional step 406, reservation management module 19 may allow host 12 to enable the auto-mode feature. As discussed above, auto-mode may allow reservation management module 19 to automatically manage and carry out all reservations of the uploaded parking location.

Step 408 of method 400 may be implemented in conjunction with guest 16. Step 408 comprises allowing guest 16 to search uploaded available vehicle parking listings 70, as discuss above. At this point, reservation management module 19 may optionally access and implement the GPS functionality 410 of guest 16 to locate uploaded available vehicle parking listings 70 in a specified/general physical proximity. At step 412, reservation management module 19 prompts guest 16 to provide a time period and payment information, as discussed above.

At step 414, based upon the information collected from guest 16, reservation management module 19 will determine whether a selected parking location is available for reservation. At step 414, a booking wizard may be displayed on guest 16 that enables guest parker to change any provided information in case there is a conflict (e.g. conflicting reservation). If it is determined that the status of the selected parking location is unavailable, at step 416, then reservation management module 19 will reject the parking location selected by the guest parker. However, if the selected parking location is available, at step 418, reservation management module 19 will approve the reservation. Reservation management module 19 may also record the status of the parking location at the reservation time period to reflect parking location unavailability. The recorded status may then be transmitted to the stored memory of one or more computing devices 12, 14, 16.

During step 418, reservation management module 19 will moreover capture payment for the reservation. This may be conducted through collaboration with at least one third-party financial services provider. A concierge system 421 may also be enabled to allow for disputes of the additional captured payment. Upon payment capture, at optional step 420, an administrator of administrator 14 may receive a portion (e.g., 20%) of the captured payment. At optional step 422, parking host may also receive a portion (e.g., 80%) of the captured payment. Once payment has been captured, at step 424, reservation management module 19 will generate and send guest 16 a confirmation notification. At optional step 426, reservation management module 19 will also generate and send guest 16 a confirmation notification.

When the parking reservation is scheduled to begin, the machine algorithm will move to step 419 and allow the reservation time period to toll for some duration of time. The machine algorithm can move to step 419 at any point after the reservation has been made (i.e., hours, days, months, or years). At some point after the reservation time period begins, the machine algorithm will move to step 428, to begin the buffer period. Accessing calendar and/or clock operations may allow reservation management module 19 to generate the buffer period, thereby providing a guest parker with sufficient notice to exit the parking location in a timely manner so that guest parker does not infringe upon a subsequent parking reservation by a third party. This buffer period may be set automatically by reservation management module 19 or it may be set by host 12 (i.e., through parking profile 38). At the beginning of the buffer period (e.g. 30 minutes prior to the reservation expiration), at step 428, the machine algorithm may move to step 430, step 132, or step 435. At step 430, reservation management module 19 will generate and send guest 16 a flexible removal notification, allowing for the option of a reservation extension of time. This type of removal notification may be generated when a flexible policy has been designated. Once the removal notification has been sent, the machine algorithm may move to step 434 or step 436. At step 434, a removal notification is sent which comprises an extension option. If an extension is made via the option, at step 439, the machine algorithm will move to step 438 to begin an extension period. Otherwise, the machine algorithm will move to step 433 and may lay dormant for some period of time. After step 433, the machine algorithm will move to step 437 at the expiration of the reservation period.

At step 436, an extension is made automatically and the machine algorithm will move to step 438. The machine algorithm may move to step 436 when guest 16 designates reservation management module 19 to do so (similar to auto-mode). Moreover, at step 436, the removal notification of step 430 may indicate an extension period will begin immediately after expiration of the reservation time period (unless guest 16 is used to indicate otherwise). Once the option is properly completed or an extension is automatic, at step 438, the reservation will generally extend the original reservation time period (made at step 419). The machine algorithm may also remain dormant at step 438 until returning to step 428 at the beginning of a reinstated buffer period. It should be appreciated that the machine algorithm may loop between steps 428 and 438 an unlimited number of times before being conditioned to move onto step 432, 433, or 437.

When the machine algorithm moves to step 435, reservation management module 19 will send a strict removal notification, which does not allow for reservation extensions. This type of removal notification may be generated when a strict policy has been designated. However, the machine algorithm may also move to step 432 after moving between steps 428 and 438 a number of times until another extension period would infringe upon other reservation rights. After the strict removal notification has been sent, reservation management module 19 may lay dormant for some period of time and will then move directly to step 437 at the expiration of the reservation.

The machine algorithm may also move to step 437 and lay dormant for the duration of the buffer period. At the expiration of the buffer period of step 428, the machine algorithm may then move to step 437. At step 437, the reservation time period has expired and the guest parker is required to remove the vehicle from the parking location.

At optional step 440, reservation management module 19 may automatically generate and send an expiration notification to guest 16 which may inform the guest parker that the parking reservation has expired and there is a possibility of an infringement of a subsequent parking reservation. Once the end time of the parking reservation is reached so that the parking reservation has expired, the machine algorithm may move to step 442, 444, or optional step 446. At step 442, reservation management module 19 allows guest 16 to manually notify administrator 14 of check-out of the parking reservation to indicate when the vehicle has been successfully removed from the parking location.

After a check-out notification has been communicated to administrator 14, at step 448, reservation management module 19 may optionally use or receive information from the GPS and/or accelerometer functions of guest 16 to verify whether the vehicle has been properly removed from the parking location. Using the GPS function of guest 16, if reservation management module 19 determines or receives information related to the geographic location of guest 16 indicating that guest 16 is a certain predetermined distance from the parking location (e.g., 0.25 miles), the machine algorithm may move to step 450 and successfully terminate the parking reservation so that the parking location returns to an available status. Further, in one aspect, if reservation management module 19 does not determine or receive information indicating that guest 16 is a certain predetermined distance from the parking location, reservation management module 19 will move to step 449 and use the accelerometer function of guest 16 to determine or receive information indicating that guest 16 is moving over a predetermined speed (e.g., 20 miles per hour). Reservation management module 19 may require guest 16 to be moving over the predetermined speed to make the determination that the vehicle has vacated the parking location. If guest 16 is determined to be moving over the predetermined speed, the machine algorithm will move to step 450 to terminate the parking reservation. However, if movement is not determined to be equal to or greater than the predetermined speed, the machine algorithm may collect an overstay fee, move to optional step 451, and contact a third-party removal services provider (e.g., towing services). After step 451, the machine algorithm will move to step 452 and reservation management module 19 will capture an additional payment (similarly to step 418). At optional step 446, reservation management module may also be configured to ensure that guest 16 remains online at the time of the reservation expiration. If reservation management module 19 is offline, the machine algorithm may move directly to step 432 to capture payment.

It should be understood that reservation management module 19 may also be configured to implement all of steps 448, 447 and 449 in any order to verify the check-out of the parking reservation to terminate the parking reservation at step 450. Further, it should be understood that, if guest 16 is not used to manually check-out of the parking reservation at step 442, the machine algorithm may move to step 444 and reservation management module 19 will operate to proceed to steps 448, 447 and/or step 449 in order to check-out of the parking reservation to terminate the parking reservation at step 450. This method of checking out of a parking reservation allows system 10 to determine whether the parking location is available for subsequent parking reservations, without having to solely rely upon a guest parker to notify administrator 14 that the parking location is vacant.

At step 452, the additional payment captured by administrator 14 may be conducted through collaboration with at least one third-party financial services provider. Upon payment capture, at optional step 454, the administrative user may receive a first payment portion (e.g., 20%) of the captured payment. At optional step 456, the parking host may also receive a second payment portion (e.g., 80%) of the captured payment. A concierge system may also be enabled at step 458 to allow for disputes of the additional captured payment. After the additional payment has been captured, the machine algorithm may move to step 460 and remain dormant for a designated time period. After remaining dormant, the machine algorithm may then return to step 428 to begin a reinstated buffer period. It should be appreciated that the machine algorithm may loop between steps 452 and 428 an unlimited number of time before being conditioned to move onto step 450. At step 452, the machine algorithm may also be configured to move to directly step 450 to terminate the reservation (i.e. when the third-party removal services have been contacted).

While exemplary machine algorithms for reservation management module 19, have been described above and with reference to FIGS. 4A and 4B, it will be understood that certain exemplary embodiments may change the order of steps in any of the machine algorithms or may even eliminate or modify certain steps. Furthermore, each of the steps in the machine algorithm described above and with reference to FIGS. 4A and 4B may be embodied as computer software stored in the computer-readable storage medium for execution by a computing device 12, 14, 16.

Having described the exemplary system and exemplary method of the present invention, an exemplary computer environment for implementing the described design and execution is presented next.

FIG. 5 shows the components of an exemplary computing environment 500 that may be used to implement any of the methods and processing thus far described. Computing environment 500 may represent one or more of host 12, administrator 14, guest 16, or server 20, comprising a system bus 524 that couples a video interface 526, network interface 528, a keyboard/mouse interface 534, and a system memory 536 to a Central Processing Unit (CPU) 538. A monitor or display 540 is connected to bus 524 by video interface 526 and provides the user with a graphical user interface to prepare, display, view, edit, and accept an available vehicle parking listing, a parking reservation request, and/or a parking reservation as described above. The graphical user interface allows the user to enter commands and information into computer 512 using a keyboard 541 and a user interface selection device 543, such as a mouse, touch screen, or other pointing device. Keyboard 541 and user interface selection device are connected to bus 524 through keyboard/mouse interface 534. The display 540 and user interface selection device 543 are used in combination to form the graphical user interface which allows the user to implement at least a portion of the present invention. Other peripheral devices may be connected to the computing device through universal serial bus (USB) drives 545 to transfer information to and from computer 512. For example, cameras and camcorders may be connected to computer 512 through serial port 532 or USB drives 545 so that data representative of a digitally image, text, music, video, or other digital content may be downloaded to memory 536 or another memory storage device, associated with computer 512 such that digital images, text, music, video, or other digital content may be subsequently prepared, displayed, viewed, edited in accordance with the present invention.

The system memory 536 is also connected to bus 524 and may include read only memory (ROM), random access memory (RAM), an operating system 544, a basic input/output system (BIOS) 546, application programs 548 and program data 550. The computer 512 may further include a hard disk drive 552 for reading from and writing to a hard disk, a magnetic disk drive 554 for reading from and writing to a removable magnetic disk (e.g., floppy disk), and an optical disk drive 556 for reading from and writing to a removable optical disk (e.g., CD ROM or other optical media). The computer 512 may also include USB drives 545 and other types of drives for reading from and writing to flash memory devices (e.g., compact flash, memory stick/PRO and DUO, SD card, multimedia card, smart media xD card), and a scanner 558 for scanning items such as digital images photographs to be downloaded to computer 512. A hard disk drive interface 552 a, magnetic disk drive interface 554 a, an optical drive interface 556 a, a USB drive interface 545 a, and a scanner interface 558 a operate to connect bus 524 to hard disk drive 552, magnetic disk drive 554, optical disk drive 556, USB drive 545 and scanner 558, respectively. Each of these drive components and their associated computer-readable media may provide computer 512 with non-volatile storage of computer-readable instruction, program management modules, data structures, application programs, an operating system, and other data for computer 512. In addition, it will be understood that computer 512 may also utilize other types of computer-readable media in addition to those types set forth herein, such as digital video disks, random access memory, read only memory, other types of flash memory cards, magnetic cassettes, and the like.

Computer 512 may operate in a networked environment using logical connections with network 18. Network interface 528 provides a communication path 560 between bus 524 and network 18, which allows, for example, an available vehicle parking listing to be communicated to administrator 14 or a parking reservation request to be communicated to administrator 14. It will be appreciated that the network connections shown herein are merely exemplary, and it is within the scope of the present invention to use other types of network connections between computer 512 and network 18 including both wired and wireless connections.

From the foregoing, it will be seen that this invention is one well adapted to attain all the ends and objects hereinabove set forth together with other advantages which are obvious and which are inherent to the method and apparatus. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. As used herein, the terms “having” and/or “including” and other terms of inclusion are terms indicative of inclusion rather than requirements.

While the invention has been described with reference to preferred embodiments, it will be understood by those skilled in the art that various changes may be made and equivalents may be substituted for elements thereof to adapt to particular situations without departing from the scope of the invention. Therefore, it is intended that the invention not be limited to the particular embodiments disclosed as the best mode contemplated for carrying out this invention, but that the invention will include all embodiments falling within the scope and spirit of the appended claims.

What is claimed is:

1. A method programmed for execution in a computing environment for managing a parking reservation of a vehicle parking location using an administrative computing device, the method comprising:
receiving an available vehicle parking listing from a host computing device over a network, the available vehicle parking listing including a vehicle parking location;
storing the available vehicle parking listing in a memory of the administrative computing device;
allowing a guest computing device to view the available vehicle parking listing on a display of the guest computing device;
receiving a parking reservation request from the guest computing device over the network, wherein the parking reservation request is associated with the available vehicle parking listing, and wherein the parking reservation request includes a reservation start time and a reservation end time;
establishing a parking reservation in response to the parking reservation request;
terminating the parking reservation upon expiration of the reservation end time; and
verifying that the vehicle parking location is vacant after expiration of the reservation end time by determining that a geographic location of the guest computing device is equal to or greater than a predetermined distance from the vehicle parking location and determining that a speed of the guest computing device is equal to or greater than a predetermined speed.

2. A method in accordance with claim 1, further comprising the step of communicating an extension of time notification to the guest computing device at a predetermined time prior to the reservation end time, wherein the extension of time notification allows the guest computing device to modify the reservation end time.

3. A method in accordance with claim 1, further comprising the step of automatically establishing the parking reservation in response to the parking reservation request as long as there is no other parking reservation that follows within a predetermined time of the reservation end time of the parking reservation request.

4. A method in accordance with claim 1, further comprising the step of receiving an acceptance notification from the host computing device prior to the step of establishing the parking reservation in response to the parking reservation request.

5. A method in accordance with claim 1, wherein the step of terminating the parking reservation further includes receiving a check-out notification from the guest computing device indicating that the vehicle parking location is vacant.

6. A method in accordance with claim 1, wherein a Global Positioning System (GPS) function of guest computing device is used to determine the geographic location of the guest computing device.

7. A method in accordance with claim 1, wherein the predetermined distance is about 0.25 miles.

8. A method in accordance with claim 1, wherein an accelerometer function of guest computing device is used to determine the speed of the guest computing device.

9. A method in accordance with claim 1, wherein the predetermined speed is about 20 miles per hour.

10. A method in accordance with claim 1, wherein the available vehicle parking listing is stored in a searchable database of the administrative computing device.

11. A method in accordance with claim 10, further comprising the step of allowing the guest computing device to search for the available vehicle parking listing in the searchable database.

12. A method in accordance with claim 11, further comprising the step of allowing the guest computing device to select the available vehicle parking listing.

13. A method in accordance with claim 1, wherein the memory that the available vehicle parking listing is stored within in located remote to the administrative computing device.

14. A method in accordance with claim 1, wherein the available vehicle parking listing further includes one or more periods of time that the vehicle parking location is available for reservation and a price for the parking location.

15. A method in accordance with claim 14, wherein the available vehicle parking listing further includes a digital image of the vehicle parking location.

16. A method in accordance with claim 1, wherein the guest computing device is a mobile computing device.

17. A vehicle parking reservation system for managing a parking reservation of a vehicle parking location, the system comprising:
an administrative computing device including a memory and a processor, wherein the administrative computing device is in communication with a host computing device and a guest computing device over a network; and
a reservation management module stored in the memory, wherein the reservation management module includes computer instructions that are executable by the processor, wherein the reservation management module is configured to:
a) receive an available vehicle parking listing from the host computing device over the network, wherein the available vehicle parking listing including a vehicle parking location;
b) store the available vehicle parking listing in the memory;
c) allow the guest computing device to view the available vehicle parking listing on a display of the guest computing device;
d) receive a parking reservation request from the guest computing device over the network, wherein the parking reservation request is associated with the available vehicle parking listing, and wherein the parking reservation request includes a reservation start time and a reservation end time;
e) establish a parking reservation in response to the parking reservation request;
f) terminate the parking reservation upon expiration of the reservation end time; and
g) verify that the parking location is vacant after expiration of the reservation end time by determining that a geographic location of the guest computing device is equal to or greater than a predetermined distance from the vehicle parking location and determining that a speed of the guest computing device is equal to or greater than a predetermined speed.

18. A system in accordance with claim 17, wherein the reservation management module is further configured to communicate an extension of time notification to the guest computing device at a predetermined time prior to the reservation end time, wherein the extension of time notification allows the guest computing device to modify the reservation end time.

19. A system in accordance with claim 17, wherein the reservation management module is further configured to automatically establish the parking reservation in response to the parking reservation request as long as there is no other parking reservation that follows within a predetermined time of the reservation end time of the parking reservation request.

20. A non-transitory computer-readable medium having thereon computer-executable instructions for performing a method for managing a parking reservation of a vehicle parking location using an administrative computing device, the method comprising:
receiving an available vehicle parking listing from a host computing device over a network, the available vehicle parking listing including a vehicle parking location;
storing the available vehicle parking listing in a memory of the administrative computing device;
allowing a guest computing device to view the available vehicle parking listing on a display of the guest computing device;
receiving a parking reservation request from the guest computing device over the network, wherein the parking reservation request is associated with the available vehicle parking listing, and wherein the parking reservation request includes a reservation start time and a reservation end time;
establishing a parking reservation in response to the parking reservation request;
terminating the parking reservation upon expiration of the reservation end time; and
verifying that the parking location is vacant after expiration of the reservation end time by determining that a geographic location of the guest computing device is equal to or greater than a predetermined distance from the vehicle parking location and determining that a speed of the guest computing device is equal to or greater than a predetermined speed.
